(19) United States
(12) Patent Application Publication
(10) Pub. No.: US 2025/0119485 A1
(43) Pub. Date: Apr. 10, 2025

(54) Intersystems Communication Using Message Identifier Mapping

(71) Applicant: Ignite Enterprise Software Solutions, LLC, Austin, TX (US)

(72) Inventor: Dmitri Anatolievich Hrapof, Yerevan (AM)

(73) Assignee: Ignite Enterprise Software Solutions, LLC, Austin, TX (US)

(21) Appl. No.: 18/912,275

(22) Filed: Oct. 10, 2024

Related U.S. Application Data
(60) Provisional application No. 63/589,275, filed on Oct. 10, 2023.

(51) Int. Cl. H04L 69/22; H04L 12/46

(52) U.S. Cl. CPC H04L 69/22; H04L 12/46

(57) ABSTRACT

An intersystems communication system and method provides a technical solution to communicate messages between multiple systems by transmitting payload data that is indeterminate from any data in the message. Transmitting data that is indeterminate from any data in the message can be very efficient by, for example, utilizing less bandwidth. In at least one embodiment, the messages include a message identifier (ID), such as a unique integer, that is associated with a specific format specification. The specific format specification includes a payload data structure definition mapped to the message ID. Thus, by linking the message ID to the specific format specification, the indeterminate data can be interpreted.

### CROSS-REFERENCE TO RELATED APPLICATION

This application claims the benefit under 35 U.S.C. § 119(e) and 37 C.F.R. § 1.78 of U.S. Provisional Application No. 63/589,275, filed Oct. 10, 2023, which is incorporated by reference in its entirety.

### BACKGROUND

### Field of the Invention

The present invention relates in general to the field of electronics, and more specifically to intersystems communication using message identifier mapping.

### DESCRIPTION OF THE RELATED ART

Nodes are assembled in a network. The nodes can be any type of device or data point in the network that can communicate with each other. Exemplary nodes include one or more computer systems running one or more applications and peripheral devices including sensors, controllers, switches, and so on. The nodes communicate with each other by transmitting messages over wired, wireless, or wired and wireless connections (collectively “communication connections”). The nodes communicate with each other by transmitting and receiving data via one or more mutually understandable communication protocols such as a hypertext transfer protocol (HTTP), transmission Control Protocol/Internet Protocol (TCCIP), Bluetooth, and other public or proprietary protocols.

Networks of nodes may be interconnected. Generally local networks communicate with each other using messages transmitted over the Internet using public communication protocols such as HTTP and TCCIP. The messages themselves are formatted to internally contain determinate payload data. Determinate payload data is data that can be directly interpreted. For example, payload data formatted using the hypertext markup language (HTML) or the extensible markup language (XML) can be directly interpreted. Encrypted data can also be directly interpreted by decrypting the data. Thus, encryption of payload data does not affect whether the payload data is determinate or not.

Different nodes within a network and different networks may internally utilize different communication protocols and payload data formats. For example, nodes in a first network may communicate using a first communication protocol and/or a first payload data format, nodes in the first network and/or a second network may communicate using a second communication protocol and/or a second payload data format, and so on. Thus, to communicate, each network and/or node may include a translator device to translate protocols and payload data formats.

### SUMMARY

In at least one embodiment, a method for at least communicating between multiple systems includes receiving a message with a first system from a second system, wherein the message includes a message identifier (ID), payload data, and an interpretation of the payload data is indeterminate from any data in the message. The method also includes accessing a mapping of the message ID to a format specification of the payload data, wherein the format specification of the payload data defines a structure of the payload data associated with the ID. The method further includes interpreting the payload data in accordance with the format specification of the payload data mapped to the message ID and performing one or more actions based on an interpretation of the payload data.

In another embodiment, an apparatus includes a first system. The first system includes an interface to receive a message from a second system, wherein the message includes a message identifier (ID), payload data, and an interpretation of the payload data is indeterminate from any data in the message. The first system also includes a bridge to (1) map the ID to a format specification of the payload data, wherein the format specification of the payload data defines a structure of the payload data associated with the ID and (2) interpret the payload data in accordance with the format specification of the payload data mapped to the ID. The first system also includes at least one first processor to perform one or more actions based on an interpretation of the payload data.

In a further embodiment, a non-transitory, computer readable medium storing code that when executed by one or more processors causes the one or more processors to perform operations that include:
receiving a message with a first system from a second system, wherein the message includes a message identifier (ID), payload data, and an interpretation of the payload data is indeterminate from any data in the message;
accessing a mapping of the message ID to a format specification of the payload data, wherein the format specification of the payload data defines a structure of the payload data associated with the ID;
interpreting the payload data in accordance with the format specification of the payload data mapped to the message ID; and
performing one or more actions based on an interpretation of the payload data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an intersystems communication system.

FIG. 2 depicts MSG interface control and configuration system.

FIG. 3 depicts an intersystems communication method.

FIG. 4 depicts a message format specification setting, mapping, and storing method.

FIG. 5 depicts a message ID-to-message format specification map.

FIG. 6 depicts a message interface.

FIG. 7 depicts an exemplary message board 700.

FIG. 8 depicts an exemplary specialized computer system.

### DETAILED DESCRIPTION

An intersystems communication system and method provides a technical solution to communicate messages between multiple systems by transmitting payload data that is indeterminate from any data in the message. Transmitting data that is indeterminate from any data in the message can be very efficient by, for example, utilizing less bandwidth. In at least one embodiment, the messages include a message identifier (ID), such as a unique integer, that is associated with a specific format specification. The specific format specification includes a payload data structure definition mapped to the message ID. Thus, by linking the message ID to the specific format specification, the indeterminate data can be interpreted. For example, message ID #127 maps to sensor 1 and the payload data is 000100100000010, which is indeterminate from any data in message ID #127. For example, payload data for sensor 1 “000100100000010” has no inherent meaning even if it is encrypted and decrypted. However, in at least one embodiment, message ID #127 maps to a specific format specification for sensor 1 and payload data type of big-endian, integer, 4 bytes sensor temperature data in degrees Fahrenheit (F). Thus, although inherently the payload data “000100100000010” is indeterminate, i.e. there is nothing in message ID #127 that indicates a meaning of the payload data, mapping the message ID #127 to the format specification for message ID #127, the payload data allows the recipient of the payload data to interpret the payload data as sensor 1 temperature=1103° F. The recipient node can then take any responsive action. For example, if the temperature is outside of a specification, either too high or too low, the recipient node can activate a temperature change procedure. If the temperature is within the specification, the recipient node can refrain from activating any temperature adjustment procedure, inform another monitoring system, and/or allow another node to proceed with or initiate another procedure. The number of messages, types of nodes and networks, and number and type of format specifications is a matter of design choice. Responsive actions occur within a context of the nodes functionality and the message interpretation.

The different systems can be individual nodes within a network and/or a collection of networks having one or more nodes. Exemplary nodes include one or more computer systems running one or more applications and devices including sensors, controllers, switches, and so on. The nodes communicate with each other by transmitting messages over wired, wireless, or wired and wireless connections (collectively “communication connections”).

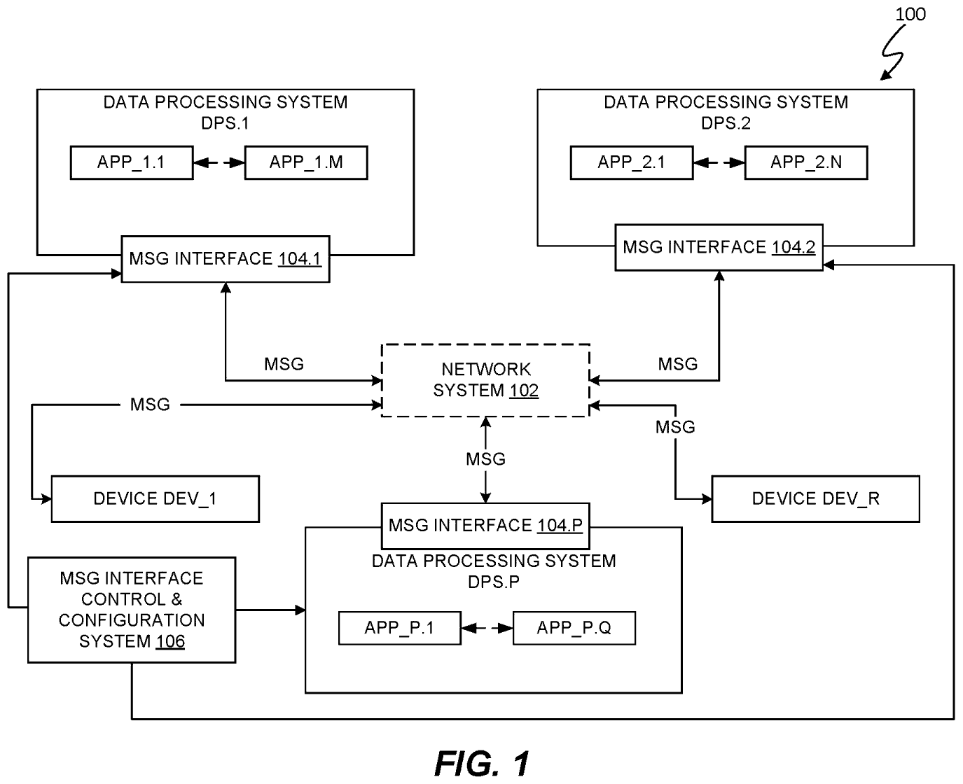

FIG. 1 depicts an intersystems communication system 100. The intersystems communication system 100 includes P data processing systems DPS.1 through DPS.P, and R devices DEV_1 through DEV_R, where P and R are positive integers representing a total number of respective data processing systems and devices. The total number of respective data processing systems and devices is a matter of design choice. Unless indicated otherwise, the nomenclature “data processing systems DPS” and “device DEV” refers generically to each of data processing systems DPS.1-DPS.P and devices DEV_1-DEV_R.

The operating environment of the intersystems communication system 100. In at least one embodiment, the intersystems communication system 100 operates within a mobile platform such as a car, truck, boat, tank, ship, aircraft, or spacecraft, or other mobile platform. In at least one embodiment, the intersystems communication system 100 operates within a fixed platform, such as a building. The types of data processing systems and devices are also matters of design choice. In at least one embodiment, each of the data processing systems DPS. 1 through DPS.P includes a computer system that is specially programmed with one or more software applications APP_1.1 through APP_P.Q. Each data processing system DPS executes one or more of the software applications APP, and the number of executing applications executed by each of the data processing systems DPS.1-DPS.P is a matter of design choice. Intersystems communication system 100 depicts data processing system DPS.1 executing M applications, data processing system DPS.2 executing N applications, and data processing system DPS.P executing Q applications, where M, N, and Q are positive integers. Exemplary devices are sensors, such as temperature, pressure, carbon dioxide, and other environmental and operational sensors, controllers, such as electric motor and engine controller, switches, computer peripherals, and any other device that transmits, receives, or exchanges data with another node.

Each data processing systems DPS.1-DPS.P and devices DEV_1-DEV_R node within intersystems communication system 100 is communicatively connected either directly or through an optional network system 102 via wired, wireless, or a combination of wired and wireless communication to at least one other node. Each node can transmit and/or receive messages MSG. Each data processing system DPS.1-DPS.P includes respective message interfaces 104.1-104.P that convert an incoming MSG into a format that is recognizable and processable by the data processing system DPS recipient. In at least one embodiment, the MSG interfaces 104 are software bridges that connect software applications and systems to allow the applications and systems to exchange data and otherwise communicate with each other. In at least one embodiment, at least one of the data processing systems DPS.1-DPS.P and/or one of the devices DEV_1-DEV_R is configured with an internal communication protocol that is different than at least one other data processing system DPS and/or device DEV. The message interfaces 104.1-104.P make it possible for all of the data processing systems DPS.1-DPS.P and the devices DEV_1-DEV_R to communicate with each other. Each message interface 104 facilitates intersystem communication using an efficient, configurable, message format specification as subsequently described.

Intersystems communication system 100 also includes a message interface control and configuration system 106 that allows a user to subscribe each MSG interface 104 to receive various messages MSG and allows a user to configure a format specification for each message MSG. In at least one embodiment, intersystems communication system 100 includes an instance of the MSG interface control and configuration system 106 for each data processing system DPS or a proper subset of the data processing systems DPS's to allow a user to separately control and configure each data processing system DPS or subset of data processing systems DPS's. In at least one embodiment, the intersystems communication system 100 utilizes one instance to allow a user to collectively control and configure all data processing systems DPS.1-DPS.P. The particular user interface design of MSG interface control and configuration system 106 is a matter of design choice.

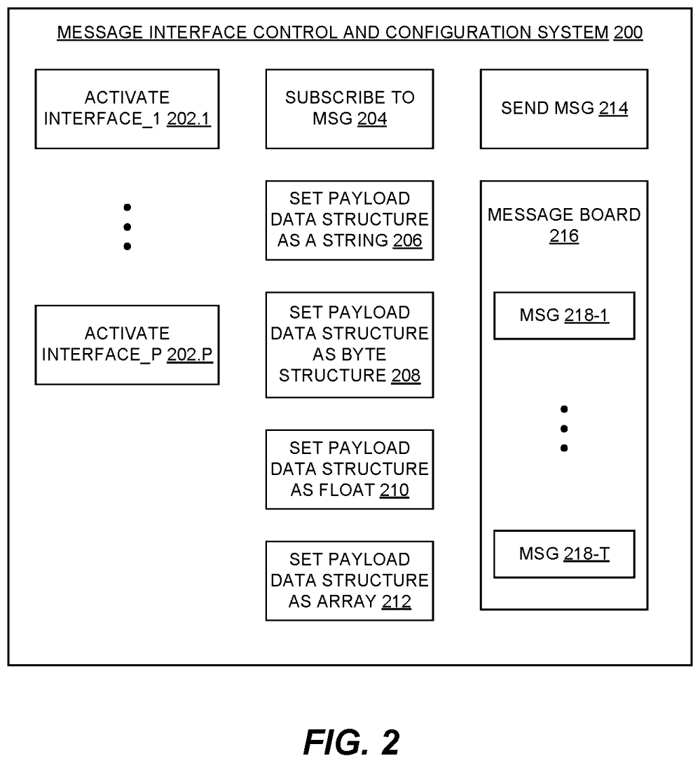

FIG. 2 depicts MSG interface control and configuration system 200, which is an embodiment of MSG interface control and configuration system 106 (FIG. 1). MSG interface control and configuration system 200 includes graphical user interface that includes multiple graphical elements to allow a user to activate message interfaces 104.1-104.P by selecting activate user interface buttons 202.1-202.P.

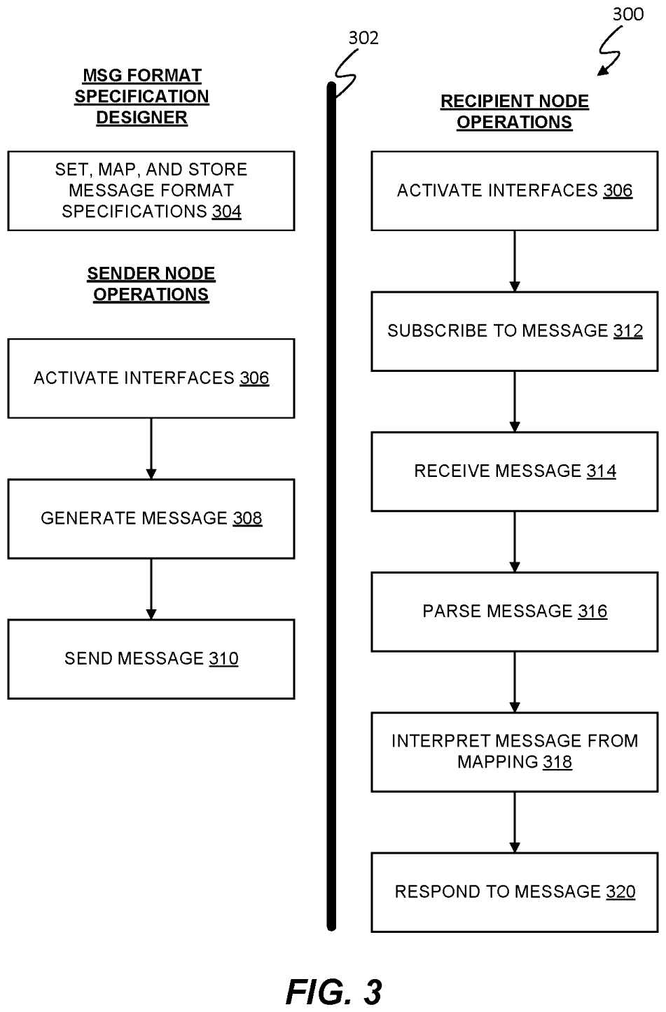

FIG. 3 depicts an intersystems communication method 300 depicting MSG format specification design and SENDER node and RECIPIENT node operations via communication connection 302, which can be a direct node-to-node connection or indirect via the network system 102 as previously described. In at least one embodiment, the intersystems communication system 100 operates in accordance with the intersystems communication method 300. Referring to FIGS. 1, 2, and 3, in operation 304, a user of the MSG interface control and configuration system 106 sets, maps, and stores message format specifications for each message MSG transmitted in the intersystems communication system 100. The particular message format specification is a matter of design choice provided that the message format specification of the payload data defines a structure of the payload data associated with a message ID, and an interpretation of the payload data in a message is indeterminate from any data in the message MSG. In an alternative embodiment, when a message MSG is generated by a node, the node sets, maps, and stores the message format specification for the MSG being generated.

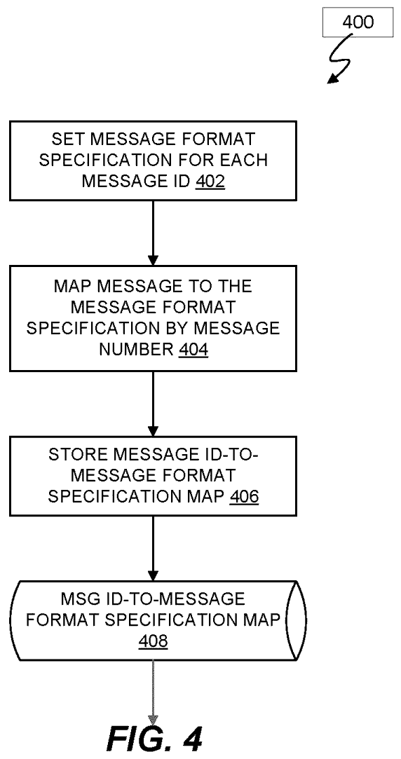

FIG. 4 depicts a message format specification setting, mapping, and storing method 400, which represents an exemplary embodiment of operation 302 (FIG. 3). In at least one embodiment, the message format specification is:

[MSG#] [TIME] [SENDER ID] [PAYLOAD DATA] [TAG (optional)], where
[MSG#] is a placeholder for a particular message identifier, such as an integer uniquely associated with a particular message, such as two byte binary representation, 4-byte binary-coded decimal, or other length or representation sufficient to uniquely identify each message MSG.
[TIME] is a placeholder for a time that the message is sent and is, for example, a binary representation of hour/minute/second (HH/MM/SS) and can also include a date.
[SENDER ID] is a placeholder for the sending node, such as any binary representation of an identifier for data processing system DPS2.
[PAYLOAD DATA] is a placeholder for the payload data in a format specified by the message format specification specified for the particular message.
[TAG] is an optional label for the payload data.

The particular structure of the payload data is a matter of design choice. For example, the payload data can be represented as:
1. 8-bit, 16-bit, 32-bit, and so on unsigned, big endian integer byte structures, which are generally abbreviated as uint8, uint16, uint32, respectively. The number of bits is a matter of design choice.
2. 16-bit, and 32-bit unsigned, little-endian integer byte structures, which are generally abbreviated as uint16le and uint32le, respectively.
3. Floating point and double floating point, big-endian ABCD format.
4. Floating point and double floating point, little-endian DCBA format.
5. Union64, which is an 8-byte union of big-endian members.
7. Union64le, which is an 8-byte union of little-endian members.
8. X-bit string, where X is any number of bits.

Furthermore, the particular organization of the payload data is a matter of design choice. For example, the payload data can be a sequence of bits or an array. Examples of the particular payload structures are:

| ● | structure(unit16): e.g. (0001 0000 0000 0000) | |
|---|---|---|
| ● | structure(unit32): e.g. (0000 0001 0000 0000 0001 0000 0000 0000) | |
| ● | structure(string): e.g. 0000101000100101 | |
| ● | structure(type: “array”, size: 4, elements: “uint8”))): | 00001101 |
| | | 00010010 |
| | | 00000000 |
| | | 00011010 |

| | |
|---|---|
| ● | structure(type: “array”, |
| | size: 32 bits, |
| | elements: |
| | structure( |
| | type: “structure”, |
| | elements: |
| | sequence( |
| | structure(type: “string”, size: 48), |
| | structure(type: “string”, size: 16), |
| | structure(type: “string”, size: 16), |
| | structure(type: “string”, size: 16), |
| | structure(type: “string”, size: 32), |
| | structure(type: “uint32”), |
| | structure(type: “uint32”), |
| | structure(type: “uint32”), |
| | structure(type: “uint32”), |
| | structure(type: “uint32”), |
| | structure(type: “uint32”), |
| | structure(type: “string”, size: 24), |
| | structure(type: “string”, size: 24) |
| | )))); //which is an array of 32 structures. |
| ● | structure(type: “array”, |
| | size: 32 bits, |
| | elements: |
| | structure( |
| | type: “structure”, |
| | elements: |
| | sequence( |
| | structure(type: “string”, size: 48, tag: “PORT-NAME”), |
| | structure(type: “string”, size: 16, tag: “PORT-DIR”), |
| | structure(type: “string”, size: 16, tag: “PORT-TYPE”), |
| | structure(type: “string”, size: 16, tag: “PORT-MODE”), |
| | structure(type: “string”, size: 32, tag: “TASK-NAME”), |
| | structure(type: “uint32”, tag: “SENT-MSGS”), |
| | structure(type: “uint32”, tag: “RECV-MSGS”), |
| | structure(type: “uint32”, tag: “SENT-MSGS-ERR”), |
| | structure(type: “uint32”, tag: “RECV-MSGS-ERR”), |
| | structure(type: “uint32”, tag: “RECV-CHANNEL”), |
| | structure(type: “uint32”, tag: “RECV-DROPS”), |
| | structure(type: “string”, size: 24, tag: “TIME-SENT”). |
| | structure(type: “string”, size: 24, tag: “TIME-RECV”) |
| | )))); //which is an array of 32 structures with tags. |

Referring to FIGS. 2 and 4, in operation 402, an MSG format specification designer sets the message format specification including the payload data structure for each message ID using the MSG interface control and configuration system 200 selects:
UI button 206 to set the payload data structure as a string structure and configure the string structure, e.g. string size 16, 32, etc.
UI button 208 to set the payload data structure as a byte structure and configure the byte structure, e.g. uint8, uint16le, etc.
UI button 210 to set the payload data structure as a floating point structure and configure the floating point structure, e.g. big-endian 32 bit.
UI button 212 to set the payload data structure as an array and configure the array, e.g. 4 elements, {string, string, byte structure, byte structure}.
   The MSG interface control and configuration system 200 can be modified in accordance with design preferences, including altering the MSG interface control and configuration system 200 to include other types of payload data structures or change the number of payload data specification options.

In operation 404, once the MSG format specification is set, the MSG interface control and configuration system 200 creates a map of the MST format specification to an MSG ID number. In at least one embodiment, the associates each MSG format specification with an MSG ID. In at least one embodiment, format features of the MSG format specification that do not change from MSG to MSG, such as [MSG#] [TIME] [SENDER ID] are set as a default and do not need to be included in the message ID-to-message format specification map 408. In operation 406, the MSG interface control and configuration system 200 stores the message ID-to-message format specification map 408 in a data storage system, such as a database.

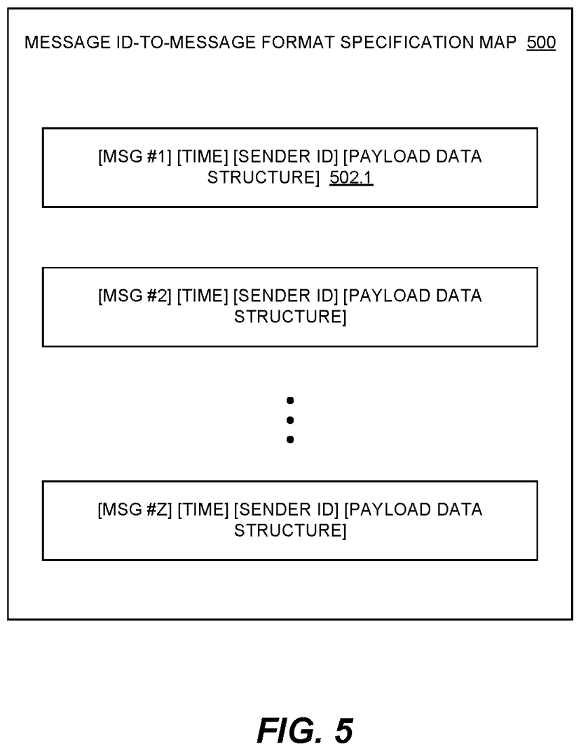

FIG. 5 depicts a message ID-to-message format specification map 500, which represents an exemplary embodiment of the message ID-to-message format specification map 408. The message ID-to-message format specification map 500 depicts message format specifications for MSG's 1-Z, where Z is an integer index representing the number of mapped message ID-to-message format specifications. An exemplary message format specification is:

[MSG ID#] [TIME] [SENDER ID] [PAYLOAD DATA]

as previously described. The particular payload data structure associated with each MSG ID is set for the particular message as, for example, described with reference to operation 402 (FIG. 4). In at least one embodiment, the message format specification also includes a byte or bit count for each of the components of the message format specification, e.g. [MSG ID#=first 3 bytes] [TIME=next 6 bytes] [SENDER ID=next 2 bytes] [PAYLOAD DATA=uint32=32 bits].

Referring to FIGS. 1, 2, and 3, in operation 306 the MSG interface control and configuration system 106 activates the MSG interfaces 104 to initialize communication connections to enable sending and receiving messages MSG with one or more nodes in intersystems communication system 100. The process of activation is matter of design choice. In at least one embodiment, selecting an activate user interface buttons 202 activates a corresponding a corresponding message interface 104 by issuing a software activation command to the selected MSG interface 104. For example, selecting activate user interface button 202.1 activates message interface 104.1, selecting activate user interface button 202.2 activates message interface 104.2, and so on. In at least one embodiment, activation of the MSG interfaces 104 is automatic when the associated data processing system DPS is operational.

In operation 308, a node in intersystems communication system 100 generates a message MSG with a message ID to be communicated to one or more other nodes. The message MSG can convey any information within the message format specification and includes the payload data structured in accordance with a payload data structure for the message with the message ID, such as sensor data, operational data, requests, responses, and any other information.

In operation 310, a node in intersystems communication system 100 sends the generated message MSG to one or more other nodes. In at least one embodiment, the node manually or automatically sends the message MSG to other nodes who have subscribed to receive the message MSG as described in more detail with reference to operation 312. In at least one embodiment, a user selects the SEND MSG button 214 in the message interface control and configuration system 200 to send the message MSG.

For MSG recipient node operations, message interfaces 104 are activated as previously discussed with respect to operation 306. Nodes can be recipients, senders, or both recipients and senders depending on the design and purpose of the node. In at least one embodiment, to receive a message MSG, a node subscribes to a message MSG ID that is relevant to the node. For example, if device DEV_1 is a pressure sensor, MSG#546 is from device DEV_1 and includes payload data, data processing system DPS_1 utilizes pressure data from device DEV_1 to determine control actions, then data processing system DPS_1 subscribes to MSG#546 in operation 312. By subscribing to particular message MSG ID's, every node, such as every data processing system DPS.1-DPS.P does not have to process each MSG, thereby providing more efficient use of data processing resources.

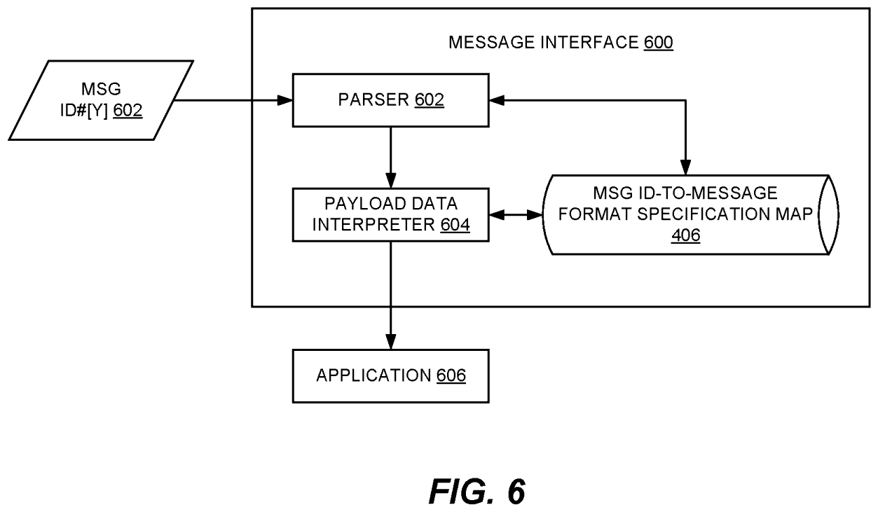

FIG. 6 depicts a message interface 600, which represents an exemplary embodiment of message interfaces 104. In at least one embodiment, message interface 600 operates in accordance with operations 314, 316, and 318 of the intersystems communication method 300 (FIG. 3). Referring to FIGS. 1, 3, and 6, in operation 314, the message interface 600 of a recipient node receives MSG ID#[Y], where Y represents any message ID number. In at least one embodiment, the node associated with the message interface 600 has subscribed to the particular MSG ID#[Y]. In operation 316, the parser 602 parses the MSG ID#[Y] into constitute components in accordance with the message format specification associated with MSG ID#[Y]. For example, if the format specification for the components of MSG ID#[Y] is [MSG#=first 3 bytes] [TIME=next 6 bytes] [SENDER ID=next 2 bytes] [PAYLOAD DATA=uint32=32 bits], parser 602 accesses the MSG ID-to-message format specification map 406 to obtain the message format specification for MSG ID#[Y] byte and/or bit count of the respective MSG ID#[Y] components. Based on the byte and/or bit count of MSG ID#[Y] components, the parser 602 parses the MSG ID#[Y].

Because the payload data in MSG ID#[Y] is indeterminate from any data in the message, in operation 318, payload data interpreter 604 accesses the MSG ID-to-message format specification map 406 to obtain the structure of the payload data in MSG ID#[Y]. Once the payload data structure for MSG ID#[Y] is interpreted, the message interface 600 provides the interpreted message MSG ID#[Y] to an application APP, such as an application APP of data processing system DPS, so that the application APP in operation 320 can respond to the MSG ID#[Y]. For example, if the payload data is uint32 from a pressure sensor node, the payload data can be interpreted as a pressure value associated with the pressure sensor node. The type of response is a matter of design choice and, for example, depends on the sender and the interpretation of the payload data and the operational features of the data processing system DPS associated with the message interface 600. For example, if the sender ID in the MSG ID#[Y] is the pressure sensor node, then an application APP of the data processing system DPS can process the pressure data to determine if the device DEV for which the pressure is sensed is operating within parameters, and, if not, the application APP can cause the data processing system DPS to issue a command to a node, such as the device DEV and/or another data processing system DPS to raise or lower the pressure and/or take any other action such as initiating a change of operation of other devices or data processing systems.

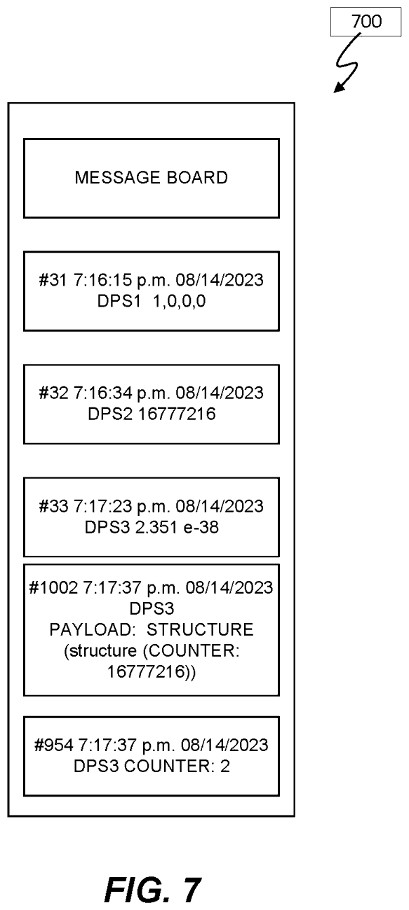

Referring to FIG. 2, the exemplary message interface control and configuration system 200 also includes a message board that displays messages for the nodes and/or for a particular node. FIG. 7 depicts an exemplary message board 700 that includes 5 exemplary messages with components of each message MSG broken down into constituent components [MSG ID#] [TIME] [SENDER ID] [PAYLOAD DATA] and a [TAG] component for MSG#954.

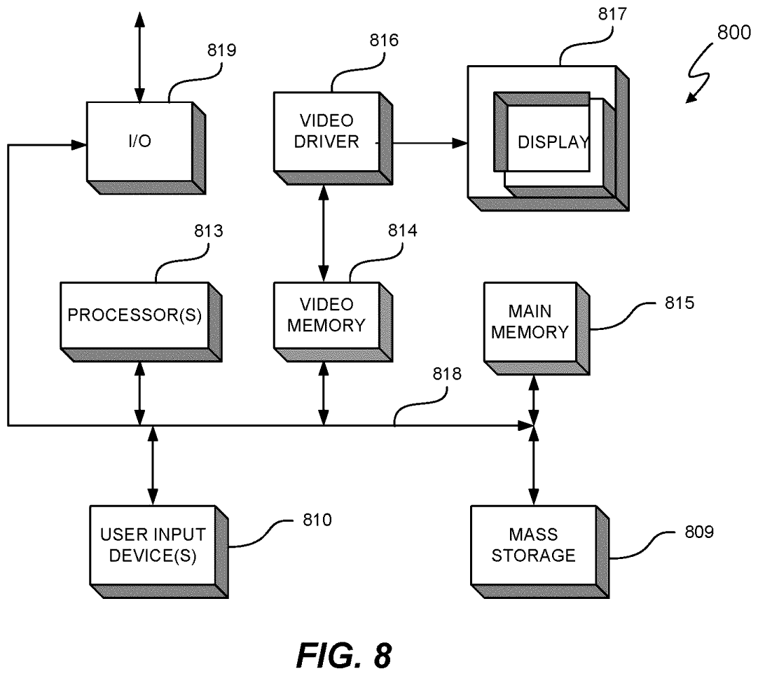

Embodiments of the intersystems communication system 100 and process 200 can be implemented on a data processing system such as a special-purpose, special programmed computer system 800 illustrated in FIG. 8. Each special-purpose, special programmed computer system 800 is a specialized computer programmed to improve conventional computer systems to utilize at least one embodiment of the intersystems communication system 100 and process 200. The programmed, computer system 800 is a specialized machine. Each computer system 800 can be specially implemented on computing devices such as server, personal, and mobile computing devices. When programmed to implement at least one embodiment of the intersystems communication system 100 and process 200, each computer system computer system 800. In at least one embodiment, the intersystems communication system 100 and process 200 can be implemented completely in hardware using, for example, logic circuits and other circuits including field programmable gate arrays.

The computer system 800 can be a dedicated computer system or a virtual, emulated system located in, for example, a cloud computing environment. Input user device(s) 810, such as a keyboard and/or mouse, are coupled to a bi-directional system bus 818. The input user device(s) 810 are for introducing user input to the computer system and communicating that user input to processor 813. The computer system of FIG. 8 generally also includes a non-transitory video memory 814, non-transitory main memory 815, and non-transitory mass storage 809, all coupled to bi-directional system bus 818 along with input user device(s) 810 and processor 813. The mass storage 809 may include both fixed and removable media, such as a hard drive, one or more CDs or DVDs, solid state memory including flash memory, and other available mass storage technology. Bus 818 may contain, for example, 32 of 64 address lines for addressing video memory 814 or main memory 815. The system bus 818 also includes, for example, an n-bit data bus for transferring DATA between and among the components, such as CPU 809, main memory 815, video memory 814 and mass storage 809, where “n” is, for example, 32 or 64. Alternatively, multiplex data/address lines may be used instead of separate data and address lines.

I/O device(s) 819 may provide connections to peripheral devices, such as a printer, and may also provide a direct connection to a remote server computer systems via a telephone link or to the Internet via an ISP. I/O device(s) 819 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code, which includes instructions and data, in a non-transient computer readable medium such as a flash memory, optical memory, magnetic memory, compact disks, digital versatile disks, and any other type of memory. The computer program is loaded from a memory, such as mass storage 809, into main memory 815 for execution. Computer programs may also be in the form of electronic signals modulated in accordance with the computer program and data communication technology when transferred via a network.

The processor 813, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 815 is comprised of dynamic random access memory (DRAM). Video memory 814 is a dual-ported video random access memory. One port of the video memory 814 is coupled to video amplifier 816. The video amplifier 816 is used to drive the display 817. Video amplifier 816 is well known in the art and may be implemented by any suitable means. This circuitry converts pixel DATA stored in video memory 814 to a raster signal suitable for use by display 817. Display 817 is a type of monitor suitable for displaying graphic images.

The computer system described above is for purposes of example only. The intersystems communication system 100 and process 200 may be implemented in any type of computer system or programming or processing environment. It is contemplated that the intersystems communication system 100 and process 200 might be run on a stand-alone computer system, such as the one described above. The intersystems communication system 100 and process 200 might also be run from a server computer system that can be accessed by a plurality of client computer systems interconnected over an intranet network.

Although embodiments have been described in detail, it should be understood that various changes, substitutions, and alterations can be made hereto without departing from the spirit and scope of the invention as defined by the appended claims.

What is claimed is:

1. A method for at least communicating between multiple systems, the method comprising:
receiving a message with a first system from a second system, wherein the message includes a message identifier (ID), payload data, and an interpretation of the payload data is indeterminate from any data in the message;
accessing a mapping of the message ID to a format specification of the payload data, wherein the format specification of the payload data defines a structure of the payload data associated with the ID;
interpreting the payload data in accordance with the format specification of the payload data mapped to the message ID; and
performing one or more actions based on an interpretation of the payload data.

2. The method of claim 1 wherein the format specification comprises a sequence having a configurable structure.

3. The method of claim 2 wherein the configurable structure comprises at least one of:
one or more binary bytes;
one or more elements and each element has multiple bytes; and
one or more elements and one or more element tags.

4. The method of claim 1 further comprising:
setting the format specification for the payload of the message having the message ID; and
mapping the format specification to the message ID.

5. The method of claim 1 further comprising:
subscribing by the first system to messages having the message ID.

6. The method of claim 1 further comprising:
communicatively coupling the first system to the second system via bridge; and
receiving the message via the bridge.

7. The method of claim 1 wherein the payload data includes one or more operating parameters of the second system, and performing one or more actions based on an interpretation of the payload data comprises:
analyzing the one or more operating parameters of the second system; and
controlling one or more operations of the second in accordance with the analysis of the one or more operating parameters.

8. An apparatus comprising:
a first system having:
an interface to receive a message from a second system, wherein the message includes a message identifier (ID), payload data, and an interpretation of the payload data is indeterminate from any data in the message;
a bridge to:
map the ID to a format specification of the payload data, wherein the format specification of the payload data defines a structure of the payload data associated with the ID; and
interpret the payload data in accordance with the format specification of the payload data mapped to the ID; and
at least one first processor to perform one or more actions based on an interpretation of the payload data.

9. The apparatus of claim 8 wherein the format specification comprises a sequence having a configurable structure.

10. The apparatus of claim 9 wherein the configurable structure comprises at least one of:
one or more binary bytes;
one or more elements and each element has multiple bytes; and
one or more elements and one or more element tags.

11. The apparatus of claim 8 further comprising:
at least one second processor; and
a memory, coupled to the at least one second processor, having code that when executed by the at least one second processor causes the at least one second processor to perform operations comprising:
setting the format specification for the payload of the message having the message ID; and
mapping the format specification to the message ID.

12. The apparatus of claim 11 wherein:
the at least one first processor includes the at least one second processor.

13. The apparatus of claim 8 further comprising:
at least one second processor; and
a memory, coupled to the at least one second processor, having code that when executed by the at least one second processor causes the at least one second processor to perform operations comprising:
subscribing by the first system to messages having the message ID.

14. The apparatus of claim 8 further comprising:
at least one second processor; and
a memory, coupled to the at least one second processor, having code that when executed by the at least one second processor causes the at least one second processor to perform operations comprising:
communicatively coupling the first system to the second system via bridge; and
receiving the message via the bridge.

15. The apparatus of claim 8 wherein the payload data includes one or more operating parameters of the second system, and to perform one or more actions based on an interpretation of the payload data comprises:
analyzing the one or more operating parameters of the second system; and
controlling one or more operations of the second in accordance with the analysis of the one or more operating parameters.

16. A non-transitory, computer readable medium storing code that when executed by one or more processors causes the one or more processors to perform operations comprising:
receiving a message with a first system from a second system, wherein the message includes a message identifier (ID), payload data, and an interpretation of the payload data is indeterminate from any data in the message;
accessing a mapping of the message ID to a format specification of the payload data, wherein the format specification of the payload data defines a structure of the payload data associated with the ID;
interpreting the payload data in accordance with the format specification of the payload data mapped to the message ID; and
performing one or more actions based on an interpretation of the payload data.

17. The non-transitory, computer readable medium of claim 16 wherein the format specification comprises a sequence having a configurable structure.

18. The non-transitory, computer readable medium of claim 17 wherein the configurable structure comprises at least one of:
one or more binary bytes;
one or more elements and each element has multiple bytes; and
one or more elements and one or more element tags.

19. The non-transitory, computer readable medium of claim 16 wherein execution of the code by the one or more processors causes the one or more processors to perform further operations comprising:
setting the format specification for the payload of the message having the message ID; and
mapping the format specification to the message ID.

20. The non-transitory, computer readable medium of claim 16 wherein execution of the code by the one or more processors causes the one or more processors to perform further operations comprising:
subscribing by the first system to messages having the message ID.

21. The non-transitory, computer readable medium of claim 16 wherein execution of the code by the one or more processors causes the one or more processors to perform further operations comprising:
communicatively coupling the first system to the second system via bridge; and
receiving the message via the bridge.

22. The non-transitory, computer readable medium of claim 16 wherein the payload data includes one or more operating parameters of the second system, and performing one or more actions based on an interpretation of the payload data comprises:
analyzing the one or more operating parameters of the second system; and
controlling one or more operations of the second in accordance with the analysis of the one or more operating parameters.
